(19) United States
(12) Patent Application Publication
(10) Pub. No.: US 2026/0355831 A1
(43) Pub. Date: Nov. 12, 2026

(54) END MILL AND METHOD FOR MACHINING A WORKPIECE WITH AN END MILL

(71) Applicant: LUKAS-ERZETT GmbH & Co. KG, Engelskirchen (DE)

(72) Inventors: Andreas METTENBÖRGER, Bergisch Gladbach (DE); Björn EDENHARTER, Much (DE)

(73) Assignee: LUKAS-ERZETT GmbH & Co. KG, Engelskirchen (DE)

(21) Appl. No.: 19/132,967

(22) PCT Filed: Dec. 4, 2023
(86) PCT No.: PCT/EP2023/084178

§ 371 Date: May 27, 2025

(30) Foreign Application Priority Data
Dec. 7, 2022 (DE) 102022132489.3

(51) Int. Cl. B23C 5/16; B23C 5/10; B24D 99/00

(52) U.S. Cl. CPC B23C 5/16; B23C 5/10; B24D 99/00; B23C 2210/24

(57) ABSTRACT

An end mill (1) including a shank (2) which can be rotatably driven about a longitudinal axis (L) of the end mill (1) and which is designed to be accommodated in a rotating tool holder of a machine tool, and a tool head (3) rigidly connected to the shank (2) with a milling section (4) which has at least one geometrically defined cutting edge (7) around its circumference about the longitudinal axis (L), wherein the tool head (3) has an grinding section (5) which has abrasive grains (17) of an abrasive material with geometrically undefined cutting edges bonded in a bonding matrix (18) around its circumference about the longitudinal axis (L).

### CROSS REFERENCE TO RELATED APPLICATIONS

This application is a National Stage of International Application No. PCT/EP 2023/084178 filed on Dec. 4, 2023, claiming priority based on German Patent Application No. 102022132489.3 filed on Dec. 7, 2022.

### BACKGROUND OF THE INVENTION

### Field

The disclosure to an end mill with a shank which can be rotatably driven about a longitudinal axis of the end mill and which is designed to be accommodated in a rotating tool holder of a machine tool. The end mill also comprises a tool head rigidly connected to the shank with at least one milling section which has at least one geometrically defined cutting edge around its circumference about the longitudinal axis.

### BACKGROUND

Such a tool is known from DE 103 18 948 A1, whereby the tool is designed as a combined drilling, roughing and finishing tool. A drilling tool is driven to rotate along an axis of rotation and only has cutting edges for cutting material at the tip, i.e. on the face side in the direction of the longitudinal axis. The cutting edges at the tip of the tool also run along a cone to make drilling easier at the start of the drilling process, as only one tip of the tool comes into contact with the workpiece to be machined. This form of cutting also improves the removal of chips. Drilling tools have no cutting edges around the circumference of the longitudinal axis. Only helical grooves are provided to remove the chips from the drill hole. A drilling tool therefore has a single machining direction in the direction of the longitudinal axis, which is also the axis of rotation.

In contrast to a drilling tool, a milling tool has one or more cutting edges around the circumference of the longitudinal axis. A milling tool can also have secondary cutting edges at the tool tip. In milling tools, the secondary cutting edges at the tip of the tool are usually arranged in a plane perpendicular to the longitudinal axis in order to form a flat surface parallel to the feed direction when the feed direction is transverse to the longitudinal axis. A milling tool can therefore machine material in different directions. The main working direction is transverse to the longitudinal axis.

The combination tool according to DE 103 18 948 A1 is a combination of a drilling tool and a milling tool. The tool has cutting edges at the tip that are arranged along a conical surface and cutting edges that are arranged around the circumference of the longitudinal axis. The cutting edges run helically around the circumference.

The cutting edges of the tool can be provided with a wear protection layer over a section in the longitudinal direction, which can, for example, contain nanocrystalline diamonds or other hard materials. This coating leaves the shape of the geometrically defined cutting edges unchanged, while the coating provides increased wear protection. This means that the tool can be used for different processing steps of the same workpiece made from the same material without having to change a tool between the processing steps. For example, a first section can be designed as a roughing section in order to process a lot of material in a short time at high feed speeds. A second longitudinal section of the tool can be designed as a finishing tool, with which smooth sur-faces can be achieved at a low feed rate. The roughing section can have serrated cutting edges, which are also coated as described above to increase the service life of the tool. For machining, for example, a plate-shaped workpiece, the tool is initially arranged in the longitudinal direction in such a way that the roughing section is aligned transversely to the plate-shaped workpiece, whereby the longitudinal axis of the tool is aligned transversely to the plane of the plate-shaped workpiece. The tool is then moved at a high feed rate in the direction of the plane of the plate-shaped workpiece in order to cut material with the main cutting edges around the circumference of the milling tool. For the finishing process, the tool is then moved axially in such a way that the finishing section of the tool is aligned at right angles to the workpiece so that the workpiece can be machined at a low feed rate in the subsequent machining step.

DE 10 2013 000 942 A1 shows a milling tool with a rotating tool head, whereby at least one cutting edge is provided in the area of a circumferential surface of the tool head. An abrasive material is arranged on the peripheral surface of the tool head adjoining the at least one cutting edge in the direction of rotation. The at least one cutting edge and the area provided with abrasive material thus overlap completely along their axial extent.

Problems arise with conventional tools when plate-shaped workpieces are made of different materials, which have a layer of a ductile material and a layer of a brittle and resistant material. In this case, tools with geometrically defined cutting edges wear faster in the area of the brittle and more wear-resistant layer of the workpiece, so that the tool must be replaced, even if the sections of the cutting edges that machine the ductile layers of the workpiece are even less worn and could be used for machining. When using tools with geometrically undefined cutting edges, these quickly become clogged in the area of the layers of the workpiece made of ductile material, so that the service life of the tool is significantly reduced compared to the areas for grinding the brittle layers.

An aspect of the present disclosure is to provide a tool with which plate-shaped workpieces made of layers of different materials can be machined, the tool having improved wear resistance and thus an increased service life.

### SUMMARY OF THE INVENTION

According to an embodiment, and end mill has a shank which can be rotatably driven about a longitudinal axis of the end mill and which is designed to be accommodated in a rotating tool holder of a machine tool, and a tool head which is rigidly connected to the shank and has at least one milling section which has at least one geometrically defined cutting edge about its circumference about the longitudinal axis. The tool head has a grinding section which has abrasive grains of an abrasive material with geometrically undefined cutting edges bonded in a bond matrix around its circumference about the longitudinal axis and which is arranged at a distance from the milling section in the direction of the longitudinal axis.

This makes the end mill suitable for processing layers of different materials of a workpiece built up in layers in a single processing step. It is an end mill that has a grinding section and can therefore also be described as a combination tool for milling and grinding. The geometrically defined cutting edges of the milling section are particularly suitable for machining ductile materials such as plastic, non-ferrous metal, aluminum and even steel. The geometrically undefined cutting edges of the grinding section are particularly suitable for hard and brittle materials such as silicon carbide, silicon, glass and ceramics. When machining hard and brittle materials, the geometrically defined cutting edges would wear faster than the geometrically undefined cutting edges of the grinding section, as the abrasive grains have a higher strength than the base material of the milling section. On the other hand, the geometrically undefined cutting edges of the grinding section would very quickly become clogged when processing soft and ductile materials and would either have to be cleaned at great expense or replaced. The combination of a milling section and a grinding section is therefore ideal for processing plate-shaped workpieces with layers of different materials in a single processing step. For this purpose, the grinding section is arranged at a distance from the milling section in the direction of the longitudinal axis. This also includes an arrangement in which the milling section and the grinding section are directly adjacent to each other. The milling section and the grinding section are arranged without overlapping in the circumferential direction around the longitudinal axis. In the circumferential direction, only one of the two sections, either the milling section or the grinding section, is in contact with the workpiece to be machined at any given segment. This does not exclude the possibility of a further section being arranged between the milling section and the grinding section, which combines the features of the milling section and the grinding section.

The milling section may only have geometrically defined cutting edges. In addition to the geometrically undefined cutting edges, the grinding section can also have geometrically defined cutting edges or a corresponding contour. However, it is also possible that the grinding section only has geometrically undefined cutting edges.

In an embodiment, the grinding section is arranged axially between the shank and the milling section.

A further milling section can be arranged between the grinding section and the shank, which has at least one geometrically defined cutting edge around its circumference about the longitudinal axis. The grinding section is therefore arranged between two milling sections and is particularly suitable for plate-shaped workpieces that have two outer layers made of a ductile material and an intermediate layer made of a brittle material, such as semiconductor chips.

In an exemplary embodiment, it is provided that the grinding section is formed by a grinding wheel formed from the abrasive grains bonded in the bonding matrix, that the milling section is formed by a milling shank, for example made of a metallic material such as hard metal, and that the grinding wheel and the milling shank are rigidly connected to one another in a material- or force-fitting manner. In addition, the grinding wheel and the shank can also be rigidly connected to each other in a material- or force-fitting manner.

A further milling shank, for example made of a metallic material such as hard metal, which forms a further milling section, can be arranged between the grinding wheel and the shank, whereby the further milling shank can be rigidly connected to the grinding wheel on the one hand and to the shank on the other in a material- or force-fitting manner.

The grinding wheel can be shaped in such a way that its outer contour corresponds to the contour of the grinding sections in such a way that it continuously continues the geometrically defined cutting edges of the grinding sections.

According to a further exemplary embodiment, the grinding section is formed by a cylindrical section with an outer circumferential surface, the bonding matrix with the abrasive grains accommodated therein being applied to the outer circumferential surface.

The cylindrical section can be formed by an outer circumferential groove.

In all embodiments, the bonding matrix can be a metallic, ceramic or synthetic resin-based bonding matrix. The abrasive grains can be completely encapsulated in the bonding matrix. The abrasive grains can have an average grain size of at least 15 μm. The abrasive material from which the abrasive grains are made can be cubic boron nitride (CBN), diamond, corundum, zirconium corundum, ceramic corundum or silicon carbide, for example.

The problem is further solved by a method for machining a workpiece with an end mill described above, wherein the workpiece comprises a plurality of planar layers of different materials. The method has the following steps:
Aligning the end mill in such a way that the longitudinal axis of the end mill is arranged transversely to planes of the layers,
Aligning the end mill in such a way that the milling section is arranged in the axial direction in a plane of a first layer and the grinding section is arranged in the axial direction in a plane of a second layer of the workpiece, and
Material-removing processing of the workpiece with the rotationally driven end mill in a feed direction parallel to the planes of the layers.

In one embodiment of the method, the milled section can be aligned in the axial direction in the plane of the first layer made of a ductile material, such as plastic, non-ferrous metal, aluminum or synthetic resin. Furthermore, the grinding section can be aligned in the axial direction in the plane of the second layer made of a brittle material, such as silicon carbide, silicon, glass or ceramic.

### BRIEF DESCRIPTION OF THE DRAWINGS

Exemplary embodiments are explained in more detail below with reference to the Figures. Herein

FIG. 1 is a perspective view of the end mill,

FIG. 2 is an enlarged perspective view of a tool tip of a first embodiment of an end mill,

FIG. 3 is an enlarged perspective view of a tool tip of a second embodiment of an end mill,

FIG. 4 is a partial longitudinal section of an end mill according to the first or second embodiment,

FIG. 5 is an enlarged longitudinal section of the end mill shown in FIG. 4 in the area of the tool tip,

FIG. 6 is an enlarged partial cross-section of a grinding wheel of the end mill shown in FIG. 5,

FIG. 7 is a partial longitudinal section of a third embodiment of an end mill,

FIG. 8 is an enlarged longitudinal section of the end mill shown in FIG. 7 in the area of the grinding section, and

FIG. 9 is a view with the arrangement of the end mill according to FIG. 1 to a plate-shaped workpiece for its machining.

### DETAILED DESCRIPTION OF THE INVENTION

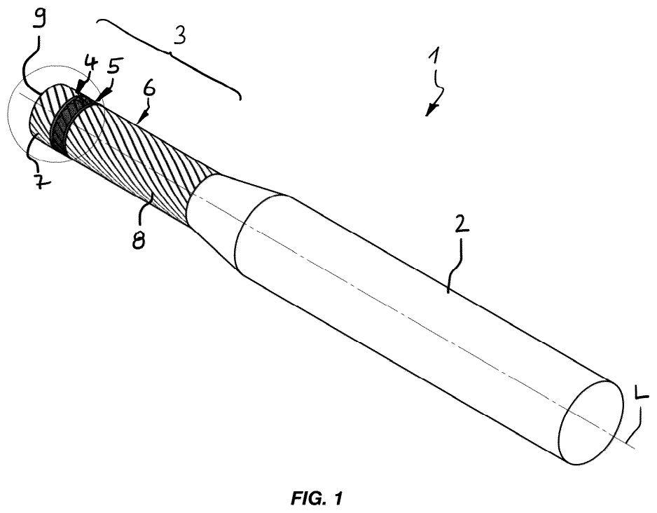

FIG. 1 shows a perspective view of an end mill 1. The end mill 1 has a shank 2 and a tool head 3. The end mill 1 or the shank 2 can be rotatably driven about a longitudinal axis L of the end mill 1. For this purpose, the shank 2 is designed to be held in a rotating tool holder (not shown here) of a machine tool. The tool head 3 is rigidly connected to the shank 2. The shank 2 and the tool head 3 can be manufactured in one piece from a common tool blank. Alternatively, the shank 2 and the tool head 3 can be made from different tool blanks that are subsequently rigidly connected to each other.

The tool head 3 has a milling section 4, a grinding section 5 adjoining it in the longitudinal direction and a further milling section 6 adjoining the grinding section 5 in the longitudinal direction. The milling section 4, the grinding section 5 and the further milling section 6 are arranged axially separated from each other in the direction of the longitudinal axis L, i.e. they do not overlap in the circumferential direction. In the design example shown, the grinding section 5 is located between the milling section 4 and the further milling section 6, whereby the further milling section 6 is arranged directly adjacent to the shank 2. In principle, it is also conceivable that there is only one milling section 4 and only one grinding section 5. It is also conceivable that several milling sections and several grinding sections are arranged alternately next to each other along the longitudinal axis L.

In the design example shown, the milling section 4 is arranged on the tool tip 9 facing away from the shank 2. It is also possible for the grinding section 5 to be arranged on the tool tip 9.

The two milling sections 4, 6 each have several geometrically defined cutting edges 7, 8 over the entire circumference, which run in a helical pattern. Geometrically defined cutting edges are characterized by the fact that the number of cutting edges, their course and the geometry of the cutting edges in the cross-section (cutting wedge) are predetermined and clearly defined.

The grinding section 5 has abrasive grains bonded into a bonding matrix around its entire circumference around the longitudinal axis L, which consist of an abrasive material with geometrically undefined cutting edges. Geometrically undefined cutting edges are characterized by the fact that the number of cutting edges, their course and the geometry of the cutting edges in the cross-section (cutting wedge) are not predetermined and not clearly defined. Abrasive grains consist in particular of cubic boron nitride (CBN), diamond, corundum, zirconium corundum, ceramic corundum or silicon carbide.

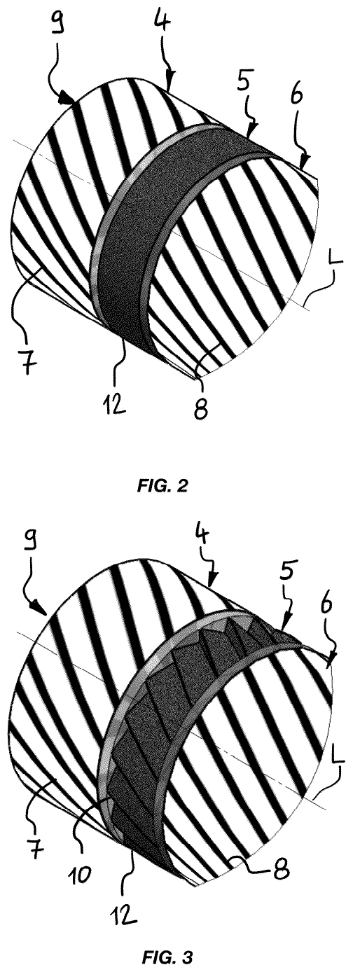

FIG. 2 shows an enlarged view of the tool head 3 in the area of the tool tip 9 of a first embodiment of the end mill 1 according to FIG. 1, whereby corresponding components are provided with the same reference signs. The first embodiment of the end mill 1 has a grinding section 5 that only has geometrically undefined cutting edges, i.e. essentially forms a cylindrical outer circumferential surface. The grinding section 5 is formed by a grinding wheel 12 formed from the abrasive grains bonded in the bonding matrix. The milling section 4 and the further milling section 6 form only geometrically defined cutting edges 7, 8. In the design example shown, the grinding section 5 is located between the milling section 4 and the further milling section 6. The milling section 4 is arranged at the tool tip 9.

FIG. 3 shows an enlarged view of the tool head 3 in the area of the tool tip 9 of a second embodiment of the end mill 1 according to FIG. 1, whereby corresponding components are provided with the same reference signs. The second embodiment of the end mill 1 has a grinding section 5 which forms geometrically undefined cutting edges and is additionally shaped in such a way that geometrically determinate cutting edges 10 are formed. The grinding section 5 is formed by a grinding wheel 12 formed from the abrasive grains bonded in the bonding matrix. As in the first embodiment, the grinding section 5 is located between the milling section 4 and the further milling section 6. The geometrically defined cutting edges 7, 8, 10 can be aligned with each other in the axial direction.

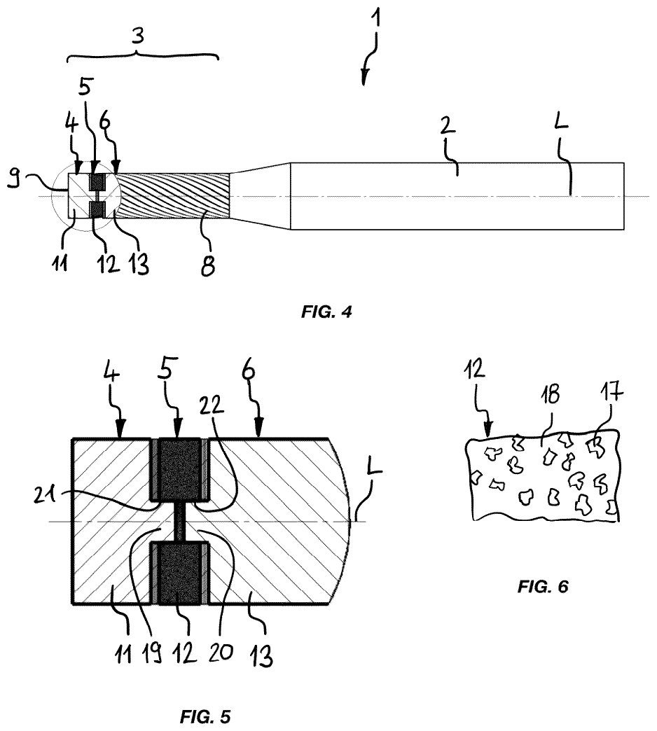

FIGS. 4 and 5 show different views of a partial longitudinal section of the first and second embodiment. It can be seen that the milling section 4 is formed by a milling shank 11. The further milling section 6 is formed by a further milling shank 13. The two milling shafts 11, 13 are designed as separate components. In the design example shown, the additional milling shank 13 is integrally, i.e. in one piece, connected to the shank 2. Alternatively, the additional milling shank 13 can be designed as a separate component from the shank 2, which is rigidly connected to the shank 2 in a material-or form-fitting manner, for example by soldering. This has the advantage that the additional milling shank 13, like the milling shank 11, can be made from a hard metal, whereas the shank 2 can be made from a steel material. The grinding wheel 12 is located between the milling shank 11 and the other milling shank 13 and is rigidly connected to them in a material- or form-fitting manner. For example, the grinding wheel 12 can be bonded or soldered to the two milling shanks 11, 13. So that the milling shanks 11, 13 and the grinding wheel 12 can be connected to each other centered in relation to each other and to the longitudinal axis L, the milling shanks 11, 13 each have central centering projections 19, 20 pointing towards the grinding wheel 12, each of which plunges into a centering recess 21, 22 of the grinding wheel 12. In principle, it is also conceivable that the milling shanks 11, 13 have no centering protrusions and the grinding wheel 12 correspondingly has no centering recesses.

For production, it is possible to first form a continuous tool blank with geometrically defined cutting edges 8. The tool tip 9 is then cut off. The grinding wheel 12 can then be rigidly connected between the milling shank 11 formed by the cut-off and the other milling shank 13.

Alternatively, a tool blank in which no geometrically defined cutting edges have yet been formed can be used initially for production. The tool tip 9 is then cut off or provided as a separate component. The grinding wheel 12 is then positioned between the two milling shanks 11, 13 and rigidly connected to them. The geometrically defined cutting edges can then be ground in continuously via the two milling sections 4, 6 and the grinding section 5.

As shown schematically in FIG. 6, the grinding wheel 12 has a metallic, ceramic or synthetic resin-based bonding matrix 18 in which abrasive grains 17 are bonded. The abrasive grains 17 consist of an abrasive material with geometrically undefined cutting edges.

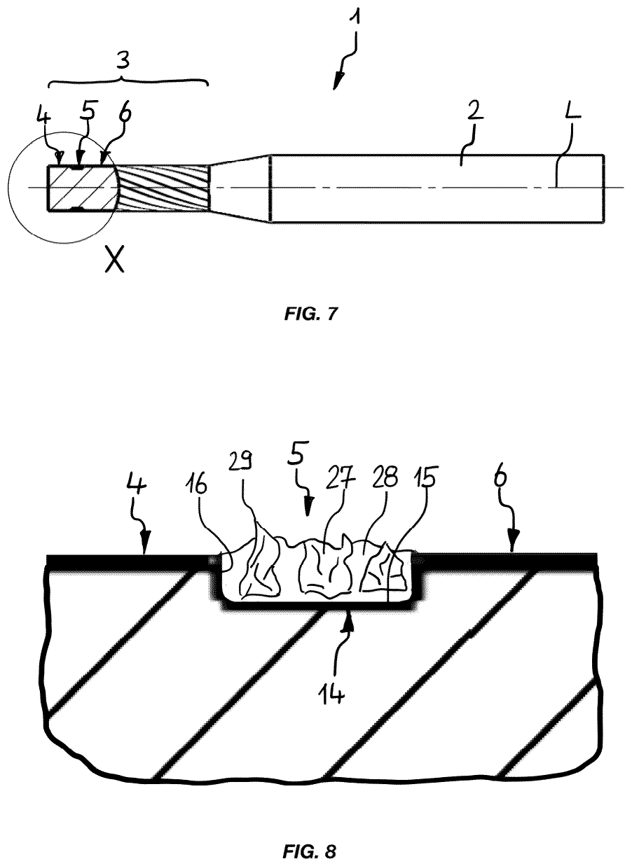

FIGS. 7 and 8 show different views of a third embodiment of the end mill 1 according to FIG. 1, whereby corresponding components are provided with the same reference symbols. The grinding section 5 is formed by a cylindrical section 14 with an outer circumferential surface 15. The outer circumferential surface 15 is coated with abrasive grains 27 held in a bonding matrix 28. Here, the outer circumferential surface 15 is formed by an outer circumferential groove 16, which is located between the milling section 4 and the further milling section 6. In this embodiment, the milling sections 4, 6, the grinding section 5 and the shank 2 are manufactured from a common tool blank. The abrasive grains 27 are accommodated in the bonding matrix 28 and protrude out-wards from it or can also be encased by it. The bonding matrix 28 is an electrochemical, for example galvanic, bonding matrix made of a nickel material. The abrasive grains 27 can be made of the same material as those of the first two embodiments. For cutting removal, the abrasive grains 17 have geometrically undefined cutting edges in the form of edges 29.

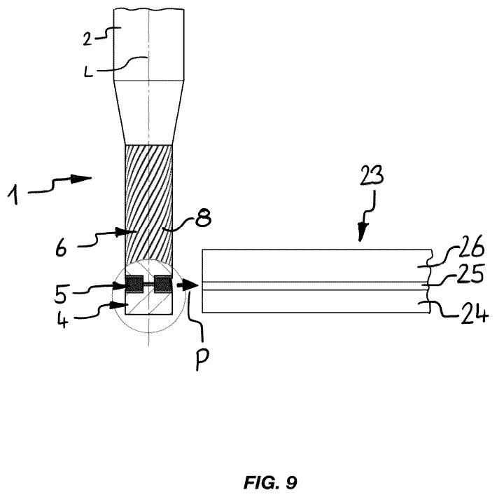

FIG. 9 shows the alignment of the end mill 1 when it is used to machine a workpiece 23. The workpiece 23 is a plate-shaped component, such as a semiconductor chip. The workpiece 23 comprises a first layer 24, a second layer 25 and a third layer 26, the second layer 25 being arranged between the first layer 24 and the third layer 26. The first layer 24 and the third layer 26 are made of a ductile or soft material, such as plastic or synthetic resin. The second layer 25 arranged in between is made of a brittle material, such as silicon carbide or silicon.

To machine the workpiece 23, the end mill 1 is aligned in such a way that the milling section 4 is arranged in the axial direction along the longitudinal axis L in a plane of the first layer 24 or overlaps with it. In addition, the grinding section 5 is arranged in the axial direction in a plane to the second layer 25. The further milling section 6 is arranged at least partially in the axial direction in a plane of the third layer 26. To machine the workpiece 23, the end mill 1 is moved transversely to the longitudinal axis L in the direction of the arrow P, while it is driven in rotation about the longitudinal axis L. The geometrically defined cutting edges 7, 8 can therefore cut the ductile material. The geometrically undefined cutting edges of the grinding wheels of the grinding section 5 are used to machine the brittle material of the second layer 25. This means that the appropriate section of the end mill 1 is used for each material of the individual layers 24, 25, 26.

### LIST OF REFERENCE SIGNS

1 End mill
2 Shank
3 Tool head
4 Milling section
5 Grinding section
6 Further milling section
7 Geometrically defined cutting edge
8 Geometrically defined cutting edge
9 Tool tip
10 Geometrically defined cutting edge
11 Milling shank
12 Grinding wheel
13 Further milling shank
14 Cylindrical section
15 Outer circumferential surface
16 Outer circumferential groove
17 Abrasive grain
18 Binding matrix
19 Centering projection
20 Centering projection
21 Centering recess
22 Centering recess
23 Workpiece
24 First layer
25 Second layer
26 Third layer
27 Abrasive grain
28 Binding matrix
29 Edge
P Arrow

1. An end mill comprising
a shank which can be rotatably driven about a longitudinal axis of the end mill and which is designed to be accommodated in a rotating tool holder of a machine tool, and
a tool head rigidly connected to the shank with a milling section which has at least one geometrically defined cutting edge around its circumference about the longitudinal axis,
wherein the tool head has a grinding section which has abrasive grains of an abrasive material with geometrically undefined cutting edges bonded in a bonding matrix around its circumference about the longitudinal axis and which is arranged at a distance from the milling section in the direction of the longitudinal axis.

2. The end mill according to claim 1,
wherein the milling section has only geometrically defined cutting edges.

3. The end mill according to claim 1, wherein
the grinding section only has geometrically undefined cutting edges.

4. The end mill according to claim 1, wherein
the grinding section is arranged axially in the direction of the longitudinal axis between the shank and the milling section.

5. The end mill according to claim 1, wherein
a further milling section is arranged axially in the direction of the longitudinal axis between the grinding section and the shank, which has at least one geometrically defined cutting edge around its circumference about the longitudinal axis.

6. The end mill according to claim 1, wherein
the grinding section is formed by a grinding wheel formed from the abrasive grains bonded in the bonding matrix,
wherein the milling section is formed by a milling shank, and
wherein the grinding wheel and the milling shank are rigidly connected to each other in a material-or force-fitting manner.

7. The end mill according to claim 6, wherein
the grinding wheel and the shank are rigidly connected to one another in a material- or force-fitting manner.

8. The end mill according to claim 6, wherein
that a further milling shank is arranged between the grinding wheel and the shank.

9. The end mill according to claim 8, wherein
the further milling shank is rigidly connected to the grinding wheel on the one hand and to the shank on the other hand in a material-or force-fitting manner.

10. The end mill according to claim 1, wherein
the grinding section is formed by a cylindrical section with an outer circumferential surface, and
wherein the bonding matrix with the abrasive grains accommodated therein is applied to the outer circumferential surface.

11. The end mill according to claim 10, wherein
the cylindrical section is formed by an outer circumferential groove.

12. A method for machining a workpiece with an end mill according to claim 1, wherein the workpiece comprises a plurality of planar layers (24, 25, 26) of different materials, comprising the steps of:
aligning the end mill in such a way that the longitudinal axis of the end mill is arranged transversely to planes of the layers,
aligning the end mill in such a way that the milling section is arranged in the axial direction in a plane of a first layer and the grinding section is arranged in the axial direction in a plane of a second layer of the workpiece and
material-removing processing of the workpiece with the rotationally driven end mill in a feed direction parallel to the planes of the layers.

13. The method according to claim 12, wherein
that the milling section is aligned in the axial direction in the plane of the first layer of a ductile material (e.g. plastic, non-ferrous metal, aluminum, synthetic resin) and
wherein the grinding section is aligned in the axial direction in the plane of the second layer made of a brittle material (e.g. silicon carbide, silicon, glass, ceramic).
